(19) United States
(12) Patent Application Publication
(10) Pub. No.: US 2017/0124858 A1
(43) Pub. Date: May 4, 2017

(54) WIRELESS COMMUNICATION CONTROL SYSTEM, WIRELESS COMMUNICATION CONTROL METHOD AND MOVABLE DEVICE

(71) Applicants: Qisda (Suzhou) Co., Ltd., Suzhou (CN); Qisda Corporation, Taoyuan (TW)

(72) Inventor: YU-FU FAN, Hsinchu (TW)

(21) Appl. No.: 15/341,002

(22) Filed: Nov. 2, 2016

(30) Foreign Application Priority Data
Nov. 3, 2015 (TW) 104136234

(51) Int. Cl. G08C 17/02; H04B 7/185

(52) U.S. Cl. CPC G08C 17/02; H04B 7/18502

(57) ABSTRACT

A wireless communication control system includes a peripheral device and a movable device capable of moving with respect to the peripheral device. The periphery device includes a plurality of first wireless communication modules. The movable device includes a control unit, a memory unit and a plurality of second wireless communication modules. Each second wireless communication module corresponds to one of the first wireless communication modules. The memory unit stores a plurality of control threshold ranges. Each of the control threshold ranges corresponds to one of the second wireless communication modules. When the control unit determines that a control parameter is within one of the control threshold ranges, the control unit selectively turns on at least one of the second wireless communication modules and turns off the other second wireless communication module (s). The control parameter includes at least one of a relative distance, a residual electrical quantity, and a relative speed.

### BACKGROUND OF THE INVENTION

1. Field of the Invention

The present invention relates to a wireless communication control system, a wireless communication control method and a movable device, and more particularly, to a wireless communication control system, a wireless communication control method and a movable device in which a plurality of wireless communication modules are selectively turned on or off based on variation of a control parameter.

2. Description of the Prior Art

As unmanned aerial vehicle technology develops, applications related to unmanned aerial vehicles have been attracting more and more attention. To dates unmanned aerial vehicles are often applied to taking photos, shipping goods and surveying specific targets. Generally speaking, an unmanned aerial vehicle is normally configured with a plurality of wireless communication modules, such as Global Positioning System (GPS) modules, WiFi modules, Bluetooth modules and 2.4 G RF modules, etc. for remote control through wireless communication. Since the distance ranges and power consumption for the aforementioned wireless communication modules are different, it is important for the unmanned aerial vehicle to automatically switch to suitable wireless communication module according to current flying status during flight.

### SUMMARY OF THE INVENTION

One of the purposes of the present invention is to provide a wireless communication control system, a wireless communication control method and a movable device in which a plurality of wireless communication modules are selectively turned on or off based on variation of a control parameter so as to solve the aforementioned problems.

According to one embodiment of the present invention, the wireless communication control system includes a peripheral device and a movable device capable of moving with respect to the peripheral device. The periphery device includes a plurality of first wireless communication modules. The movable device includes a control unit, a memory unit and a plurality of second wireless communication modules. Each second wireless communication module corresponds to one of the first wireless communication modules. The memory unit stores a plurality of control threshold ranges. Each of the control threshold ranges corresponds to one of the second wireless communication modules. When the control unit determines that a control parameter is within one of the control threshold ranges, the control unit selectively turns on at least one of the second wireless communication modules and turns off the other second wireless communication module (s). The control parameter includes at least one of a relative distance, a residual electrical quantity, and a relative speed.

According to another embodiment of the present invention, the wireless communication control method is applicable to a movable device. The movable device is capable of moving with respect to a peripheral device. The peripheral device includes a plurality of first wireless communication modules. The movable device includes a memory unit and a plurality of second wireless communication modules. Each of the second wireless communication modules corresponds to one of the first wireless communication modules. The memory unit stores a plurality of control threshold ranges. Each of the control threshold ranges corresponds to one of the second wireless communication modules. The wireless communication control method includes the steps of: comparing a control parameter with the control threshold ranges, wherein the control parameter includes at least one of a relative distance between the movable device and the peripheral device, a residual electrical quantity of the movable device, and a relative speed between the movable device and the peripheral device; and turning on at least one of the second wireless communication modules and turning off the other second wireless communication module (s) when the control parameter is within one of the control threshold ranges.

According to yet another embodiment of the present invention, the movable device is capable of moving with respect to a peripheral device. The peripheral device includes a plurality of first wireless communication modules. The movable device includes a plurality of second wireless communication modules, a memory unit and a control unit. The control unit is coupled to the memory unit and the second wireless communication modules. Each of the second wireless communication modules corresponds to one of the first wireless communication modules. The memory unit stores a plurality of control threshold ranges. Each of the control threshold ranges corresponds to one of the second wireless communication modules. When the control unit determines that a control parameter is within one of the control threshold ranges, the control unit selectively turns on at least one of the second wireless communication modules and turns off the other second wireless communication module(s), wherein the control parameter includes at least one of a relative distance between the movable device and the peripheral device, a residual electrical quantity of the movable device, and a relative speed between the movable device and the peripheral device.

In sum, during movement of the movable device with respect to the peripheral device, the movable device turns on the wireless communication module(s) suitable to the current control parameter and turns off the other wireless communication module(s) based on variation of the control parameter. Therefore, safety assurance and power conservation of the movable device are achieved.

The above-mentioned and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a wireless communication control system according to an embodiment of the present invention;

FIG. 2 is a schematic diagram of comprehensive consideration of the distance, the speed and the electrical quantity of a movable device according to an embodiment of the present invention; and

FIG. 3 is a flowchart of a wireless communication control method according to an embodiment of the present invention.

### DETAILED DESCRIPTION OF PREFERRED EMBODIMENTS

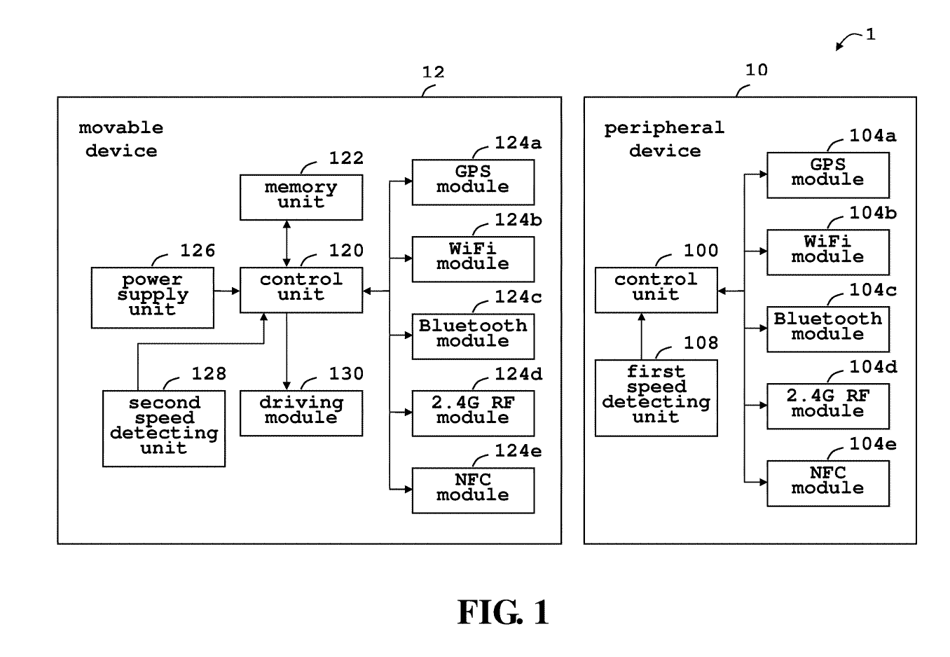

Please refer to FIG. 1. FIG. 1 is a functional block diagram of a wireless communication control system 1 according to an embodiment of the present invention. As shown in FIG. 1, the wireless communication control system 1 includes a peripheral device 10 and a movable device 12. In the embodiment, the peripheral device 10 may be an unmanned aerial vehicle, an automatic guided vehicle, a smart watch or a mobile phone worn on a human body, or other types of electronic device. The movable device 12 may be an unmanned aerial vehicle, an automatic guided vehicle or other types of unmanned vehicle capable of moving with respect to the peripheral device 10.

In the embodiment of present invention, the peripheral device includes a control unit 100, a plurality of first wireless communication modules and a first speed detecting unit 108. The control unit 100 is coupled to the first wireless communication modules and the first speed detecting unit 108. In actual applications, the control unit 100 may be a processor or a controller capable of processing data. General speaking, the peripheral 10 also includes other hardware and software required for operation, such as operation system, application software, printed circuit boards, display module and power supply, etc., depending upon actual applications.

In the embodiment, the movable device 12 includes a control unit 120, a memory unit 122, a plurality of second wireless communication modules, a power supply unit 126, a second speed detecting unit 128 and a driving module 130. The control unit 120 is coupled to the memory unit 122, the second wireless communication modules, the power supply 126, the second speed detecting unit 128 and the driving module 120. In actual applications, the control unit 120 may be a processor or a controller capable of processing data. The memory unit 122 may be a memory or other types of storage device. The power supply unit 126 may be a battery or other types of power supply. General speaking, the movable device 12 also includes other hardware and software required for operation, such as operation system, application software, printed circuit boards, display module and power supply, etc., depending upon actual applications.

When the movable device 12 is an unmanned aerial vehicle, the driving module 120 may include a plurality of motors for driving the rotor wings and controlling the speed and the direction of the unmanned aerial vehicle. The second speed detecting unit 128 may be a Pitot tube for measuring the total pressure of the unmanned aerial vehicle during flying. The control unit 120 then calculates the flying speed of the unmanned aerial vehicle based on the measured total pressure. It is to be understood that the flying theory and speed measurement of the unmanned aerial vehicle are well known by people having ordinary skill in the art and are not repeatedly described in details herein. Similarly, when the movable device 12 is an automatic guided vehicle or other types of unmanned vehicle, the movement theory and speed measurement of the unmanned aerial vehicle are also well known by people having ordinary skill in the art and are not repeatedly described in details herein. Moreover, when the peripheral 10 is an unmanned aerial vehicle, the first speed detecting unit 108 may also be a Pitot tube for measuring the total pressure of the unmanned aerial vehicle during flying. The control unit 100 then calculates the flying speed of the unmanned aerial vehicle based on the measured total pressure. When the peripheral 10 is an automatic guided vehicle or other types of unmanned vehicle, the movement theory and speed measurement of the unmanned aerial vehicle are also well known by people having ordinary skill in the art and are not repeatedly described in details herein.

In the embodiment, there are five first wireless communication modules incorporated in the peripheral device 10, including a Global Positioning System (GPS) module 104a, a WiFi module 104b, a Bluetooth module 104c, a 2.4G RF module 104d and a Near Field Communication (NFC) module 104e. There are five second wireless communication modules as well incorporated in the movable device 12, including a GPS module 124a, a WiFi module 124b, a Bluetooth module 124c, a 2.4G RF module 124d and a NFC module 124e. As shown in FIG. 1, each of the second wireless communication modules corresponds to one of the first wireless communication modules. It is to be understood that the types and the quantities of the first wireless communication modules and the second wireless communication modules are determined based on actual applications and are not limited to what is described in the embodiment.

In the embodiment, the memory unit 122 stores a plurality of control threshold ranges. Each of the control threshold ranges corresponds to one of the second wireless communication modules. When the control unit 120 determines that a control parameter is within one of the control threshold ranges, the control unit 120 selectively turns on at least one of the second wireless communication modules and turns off the other second wireless communication module (s). The control parameter includes at least one of a relative distance between the movable device 12 and the peripheral device 10, a residual electrical quantity of the movable device 12, and a relative speed between the movable device 12 and the peripheral device 10. In the embodiment, “turn on” means maintaining the second wireless communication module in the operation status when the second wireless communication module is already in the operation status, or enabling the second wireless communication module when the second wireless communication module is not in the operation status yet.

When the control parameter includes the relative distance between the movable device 12 and the peripheral device 10, the control threshold ranges include a plurality of distance threshold ranges. Each of the distance threshold ranges corresponds to one of the second wireless communication modules. The control unit 120 obtains the relative distance between the movable device 12 and the peripheral device 10 based on at least one of a sensing result of one of the first wireless communication modules and a sensing result of one of the corresponding second wireless communication modules.

Take GPS for example. The movable device 12 transmits the coordinate sensed by the GPS module 124a to a server (not shown in FIG. 1), and the peripheral device 10 also transmits the coordinate sensed by the GPS module 104a to the server. The server then calculates the relative distance between the movable device 12 and the peripheral device 10 based on Formulas 1 and 2 below, and transmits the relative distance to the movable device 12.

$$\begin{matrix}Δ \hat{σ} = 2 {sin}^{- 1} \sqrt{{sin}^{2} ( \frac{Δ φ}{2} ) + cos {φ}_{s} cos {φ}_{f} {sin}^{2} ( \frac{Δ λ}{2} )} & Formula 1 \\ d = r Δ \hat{σ} & Formula 2\end{matrix}$$

In Formulas 1 and 2, d represents the relative distance between the movable device 12 and the peripheral device 10, r represents the radius of the earth, φₛ represents the longitude of the movable device 12, φ_{f} represents the longitude of t the peripheral device 10, Δφ represents the absolute value of the difference between the longitude of the movable device 12 and the longitude of the peripheral device 10, and Δλ represents the absolute value of the difference between the latitude of the movable device 12 and the latitude of the peripheral device 10.

It is to be understood that the peripheral device 10 may alternatively transmits the coordinate sensed by the GPS module 104a to the movable device 12 through the Internet network, and the control unit 120 of the movable device 12 then calculates the relative distance between the movable device 12 and the peripheral device 10 based on Formulas 1 and 2 described above.

As far as WiFi, Bluetooth and 2.4G RF are concerned, the control unit 120 of the movable device 12 calculates the relative distance between the movable device 12 and the peripheral device 10 based on the Received Signal Strength Indication (RSSI). For example, the control unit 120 of the movable device 12 calculates the relative distance between the movable device 12 and the peripheral device 10 based on Formula 3 below.

d=10^{[P}^{ₒ}^{-F}^{ₘ}^{-P}^{ᵣ}^{-10×n×log}^{₁₀}^{(f)+30×n-32.44)/10×n]} Formula 3:

In Formula 3, d represents the relative distance between the movable device 12 and the peripheral device 10, Fₘ represents the fading margin, i.e. the amount by which a received signal level may be reduced without causing system performance to fall below a specific threshold value, n represents the path loss exponent, i.e. the reduction in power density (attenuation) of an electromagnetic wave as it propagates through space, Pₒ represents the energy transmitted by the antenna, Pᵣ represents the energy received by the antenna, and f represents the signal frequency. It is to be understood that there is more than one algorithm for calculating the distance based on RSSI. Formula 3 described in the embodiment of present invention is one of the well-known and popular algorithms. The invention is not limited to use aforementioned Formula 3 to calculate the relative distance between the movable device 12 and the peripheral device 10.

In the embodiment of present invention, the GPS module 124a, the WiFi module 124b, the Bluetooth module 124c and the 2.4G RF module 124d are predetermined to correspond to different distance threshold ranges as shown in Table 1 below. It is to be understood that the distance threshold ranges in Table 1 may be adjusted upon actual applications, and are not so limited.

TABLE 1

| | second wireless | |
|---|---|---|
| | communication | |
| | module | distance threshold range |
| 4^{th} | GPS module 124a | farthest distance acceptable to wireless |
| | | communication technology ≧ relative |
| | | distance ≧ 100 meters |
| 3^{rd} | WiFi module 124b | 100 meters > relative distance ≧ 10 meters |
| 2^{nd} | Bluetooth module | 10 meters > relative distance ≧ 5 meters |
| | 124c | |
| 1^{st} | 2.4G RF module | 5 meters > relative distance ≧ 10 |
| | 124d | centimeters |

In the embodiment of present invention, there are a distance priority mode and a collision, avoidance mode for operation of the movable device 12. When the user sets the movable device 12 to operate in the distance priority mode, the control unit 120 of the movable device 12 selectively turns on one of the second wireless communication modules and turns off the other second wireless communication modules based on the relative distance between the movable device 12 and the peripheral device 10. Under the distance priority mode, when the control unit 120 determines that the relative distance between the movable device 12 and the peripheral device 10 is within a tolerance range corresponding to the Ith distance threshold range, the control unit 120 turns on the Ith second wireless communication module corresponding to the Ith distance threshold range and turns off the other second wireless communication modules, wherein I is a positive integer.

Take Table 1 for example. When the relative distance between the movable device 12 and the peripheral device 10 is within the tolerance range corresponding to the 3rd distance threshold range which corresponds to the WiFi module 124b, the control unit 120 turns on the 3rd second wireless communication module, i.e. the WiFi module 124b, corresponding to the 3rd distance threshold range and turns off the other second wireless communication modules, i.e. the GPS module 124a, the Bluetooth module 124c and the 2.4G RF module 124d. Under this circumstance, since only one second wireless communication module is turned on, power of the movable device 12 is saved.

When the user sets the movable device 12 to operate in the collision avoidance mode, the control unit 120 of the movable device 12 selectively turns on two of the second wireless communication modules and turns off the other second wireless communication modules based on the relative distance between the movable device 12 and the peripheral device 10. Under the collision avoidance mode, when the control unit 120 determines that the relative distance between the movable device 12 and the peripheral device 10 is within a tolerance range corresponding to the Ith distance threshold range and I is a positive integer greater than 1, the control unit turns on the Ith second wireless communication module corresponding to the Ith distance threshold range and the I−1th second wireless communication module corresponding to the I−1th distance threshold range and turns off the other second wireless communication modules, wherein the Ith distance threshold range is greater than the I−1th distance threshold range.

Take Table 1 for example. When the relative distance between the movable device 12 and the peripheral device 10 is within the tolerance range corresponding to the 3rd distance threshold range which corresponds to the WiFi module 124b, the control unit 120 turns on the 3rd second wireless communication module, i.e. the WiFi module 124b, corresponding to the 3rd distance threshold range as well as the 2nd second wireless communication module, i.e. the Bluetooth module 124c, corresponding to the 2nd distance threshold range and turns off the other second wireless communication modules, i.e. the GPS module 124a and the 2.4G RF module 124d. Under this circumstance, since only two second wireless communication modules are turned on, power of the movable device 12 is saved. Moreover, when the relative distance between the movable device 12 and the peripheral device 10 is within the tolerance range corresponding to the 3rd distance threshold range which corresponds to the WiFi module 124b, since both the WiFi module 124b and the Bluetooth module 124c are turned on, even if the relative distance between the movable device 12 and the peripheral device 10 decreases rapidly and falls into the tolerance range corresponding to the 2nd distance threshold range which corresponds to the Bluetooth module 124c, the control unit 120 is still capable of measuring the relative distance in time by the Bluetooth module 124c instead of the WiFi module 124b. No collision due to insufficient time for measurement would occur.

When the control parameter includes the residual electrical quantity of the movable device 12, the control threshold ranges include a plurality of electrical quantity threshold ranges. Each of the electrical quantity threshold ranges corresponds to one of the second wireless communication modules. The control unit 120 is capable of obtaining the residual electrical quantity of the movable device 12 from the power supply unit 126.

In the embodiment of present invention, the GPS module 124a, the WiFi module 124b, the Bluetooth module 124c and the 2.4G RF module 124d are predetermined to correspond to different electrical quantity threshold ranges as shown in Table 2 below. It is to be understood that the electrical quantity threshold ranges in Table 2 may be adjusted upon actual applications, and are not so limited.

TABLE 2

| | second wireless | |
|---|---|---|
| | communication | |
| | module | electrical quantity threshold range |
| 4^{th} | GPS module 124a | 100% ≧ residual electrical quantity ≧ 70% |
| 3^{rd} | WiFi module 124b | 70% > residual electrical quantity ≧ 40% |
| 2^{nd} | Bluetooth module | 40% > residual electrical quantity ≧ 20% |
| | 124c | |
| 1^{st} | 2.4G RF module | 20% > residual electrical quantity ≧ 0% |
| | 124d | |

In the embodiment of present invention, the movable device 12 may be set to operate in an electrical quantity priority mode. When the user sets the movable device 12 to operate the electrical quantity priority mode, the control unit 120 of the movable device 12 selectively turns on one of the second wireless communication modules and turns off the other second wireless communication modules based on the residual electrical quantity of the movable device 12. Under the electrical quantity priority mode, when the control unit 120 of the movable device 12 determines that the residual electrical quantity of the movable device 12 is within a tolerance range corresponding to the Jth electrical quantity threshold range, the control unit 120 turns on the Jth second wireless communication module corresponding to the Jth electrical quantity threshold range and turns off the other second wireless communication modules, wherein J is a positive integer.

Take Table 2 for example. When the control unit 120 determines that the residual electrical quantity of the movable device 12 is within the tolerance range corresponding to the 2nd electrical quantity threshold range which corresponds to the Bluetooth module 124c, the control unit 120 turns on the 2nd second wireless communication module, i.e. the Bluetooth module 124c, corresponding to the 2nd electrical quantity threshold range and turns off the other second wireless communication modules, i.e. the GPS module 124a, the WiFi module 124b and the 2.4G RF module 124d. Under this circumstance, since only one second wireless communication module is turned on, power of the movable device 12 is saved.

When the control parameter includes the relative speed between the movable device 12 and the peripheral device 10, the control threshold ranges include a plurality of speed threshold ranges. Each of the speed threshold ranges corresponds to one of the second wireless communication modules. The control unit 120 obtains the relative speed between the movable device 12 and the peripheral device 10 based on a sensing result of the first speed detecting unit 108 and a sensing result of the second speed detecting unit 128. Furthermore, the movable device 12 may transmit to a server (not shown) the speed of the movable device 12 itself detected by the second speed detecting unit 128, and the peripheral device 10 may transmit to the server the speed of the peripheral device 10 itself detected by the first speed detecting unit 108. The server then calculates the relative speed between the movable device 12 and the peripheral device 10 and transmits the relative speed to the movable device 12. Of course, the peripheral device 10 may alternatively transmit to the movable device 1 the speed of the peripheral device 10 itself detected by the first speed detecting unit 108 through an Internet network, and the control unit 120 of the movable device 12 then calculates the relative speed between the movable device 12 and the peripheral device 10.

In the embodiment of present invention, the GPS module 124a, the WiFi module 124b, the Bluetooth module 124c and the 2.4G RF module 124d are predetermined to correspond to different speed threshold ranges as shown in Table 3 below. It is to be understood that the speed threshold ranges in Table 3 may be adjusted upon actual applications, and are not so limited.

TABLE 3

| | second wireless | |
|---|---|---|
| | communication | |
| | module | speed threshold range |
| 4^{th} | GPS module 124a | highest speed of the movable device 12 ≧ |
| | | relative speed ≧ 15 km/h |
| 3^{rd} | WiFi module 124b | 15 km/h > relative speed ≧ 8 km/h |
| 2^{nd} | Bluetooth module 124c | 8 km/h > relative speed ≧ 2 km/h |
| 1^{st} | 2.4G RF module 124d | 2 km/h > relative speed ≧ 0 km/h |

In the embodiment of present invention, the movable device 12 may be set to operate in a speed priority mode. When the user sets the movable device 12 to operate in the speed priority mode, the control unit 120 of the movable device 12 selectively turns on one of the second wireless communication modules and turns off the other second wireless communication modules based on the relative speed between the movable device 12 and the peripheral device 10. Under the speed priority mode, when the control unit 120 determines that the relative speed is within a tolerance range corresponding to the kth speed threshold range, the control unit 120 turns on the kth second wireless communication module corresponding to the kth speed threshold range and turns off the other second wireless communication modules, wherein k is a positive integer.

Take Table 3 for example. When the control unit 120 determines that the relative speed between the movable device 12 and the peripheral device 10 is within the tolerance range of the 1st speed threshold range which corresponds to the 2.4G RF module 124d, the control unit 120 turns on the 1st second wireless communication module, i.e. the 2.4G RF module 124d, corresponding to the 1st speed threshold range and turns off the other second wireless communication modules, i.e. the GPS module 124a, the WiFi module 124b and the Bluetooth module 124c. Under this circumstance, since only one second wireless communication module is turned on, power of the movable device 12 is saved.

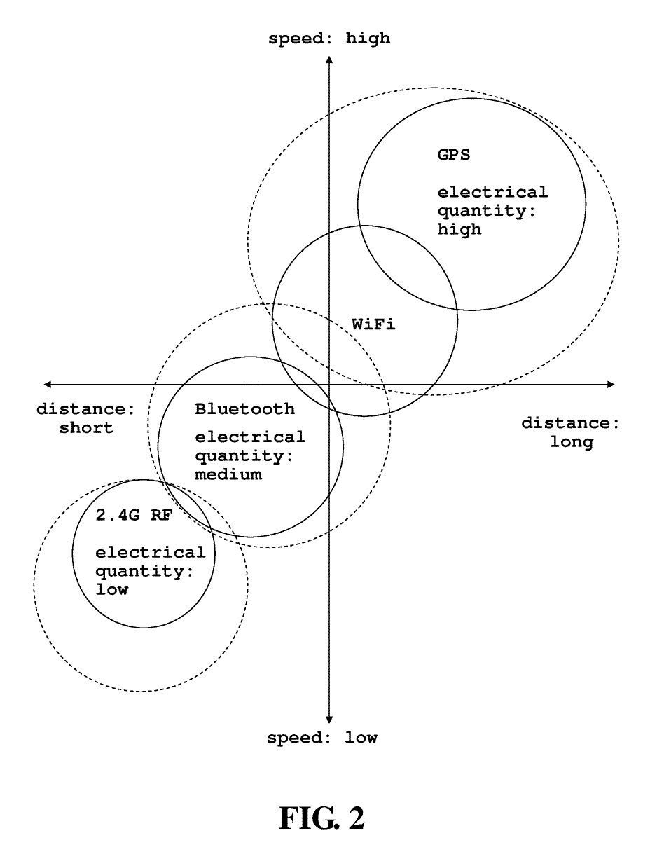

Please refer to FIG. 2. FIG. 2 is a schematic diagram of comprehensive consideration of the relative distance between the movable device 12 and the peripheral device 10, the relative speed between the movable device 12 and the peripheral device 10 and the electrical quantity of the movable device 12 according to an embodiment of the present invention. As shown in FIG. 2, in addition to the distance priority mode, the collision avoidance mode, the electrical quantity priority mode and the speed priority mode, in the embodiment the second wireless communication modules may be turned on and off based on more than one of the relative distance between the movable device 12 and the peripheral device 10, the relative speed between the movable device 12 and the peripheral device 10 and the electrical quantity of the movable device 12, wherein the order of reference may be the relative distance first, then the relative speed, and then the electrical quantity, but is not so limited.

Moreover, since NFC is a high frequency wireless communication technology applicable to a short distance, and non-contact point-to-point data transmission between electronic devices is allowed only within 10 cm, when the NFC module 124e of the movable device 12 detects the NFC module 104e of the peripheral device 10, meaning that the movable device 12 is quite close to the peripheral device 10. The control unit 120 thus would control the driving module 130 to stop movement of the movable device 12 right away so as to avoid collision between the movable device 12 and the peripheral device 10.

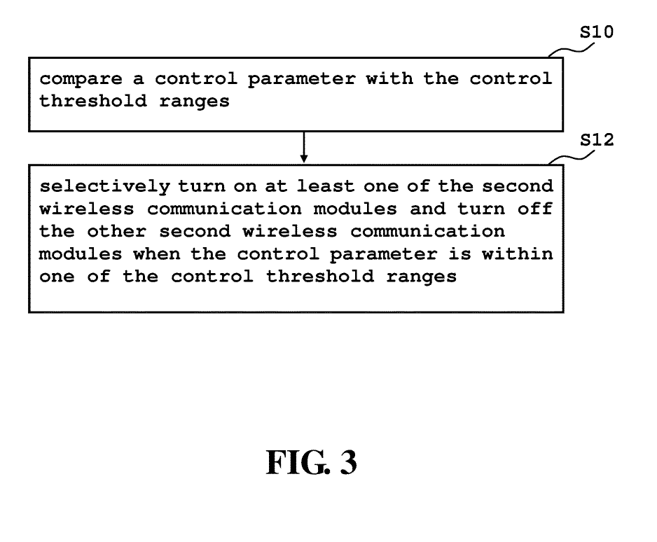

Please refer to FIG. 3. FIG. 3 is a flowchart of a wireless communication control method according to an embodiment of the present invention. The wireless communication control method of FIG. 3 is applicable to the aforementioned wireless communication control system 1. First, Step S10 is executed to compare a control parameter with the control threshold ranges, wherein the control parameter includes at least one of a relative distance between the movable device 12 and the peripheral device 10, a residual electrical quantity of the movable device 12, and a relative speed between the movable device and the peripheral device 10. Then Step S12 is executed to selectively turn on at least one of the second wireless communication modules and turn off the other second wireless communication modules when the control parameter is within one of the control threshold ranges. It is to be understood that the detailed embodiment for the wireless communication control method can be understood by referring to those description of the operation of the aforementioned wireless communication control system 1, and is not repeatedly described in details herein.

In sum, during movement of the movable device with respect to the peripheral device, the movable device turns on the wireless communication module(s) suitable to the current control parameter and turns off the other wireless communication module(s) based on variation of the control parameter. Therefore, safety assurance and power conservation of the movable device are achieved.

Those skilled in the art will readily observe that numerous modifications and alterations of the system and method may be made while retaining the teachings of the invention.

What is claimed is:

1. A wireless communication control system comprising:
a peripheral device comprising a plurality of first wireless communication modules; and
a movable device capable of moving with respect to the peripheral device, the movable device comprising a control unit, a memory unit and a plurality of second wireless communication modules, wherein each of the second wireless communication modules corresponds to one of the first wireless communication modules, the control unit is coupled to the memory unit and the second wireless communication modules, the memory unit stores a plurality of control threshold ranges, each of the control threshold ranges corresponds to one of the second wireless communication modules, when the control unit determines that a control parameter is within one of the control threshold ranges, the control unit selectively turns on at least one of the second wireless communication modules and turns off the other second wireless communication module(s), and the control parameter comprises at least one of a relative distance between the movable device and the peripheral device, a residual electrical quantity of the movable device, and a relative speed between the movable device and the peripheral device.

2. The wireless communication control system of claim 1, wherein when the control parameter comprises the relative distance between the movable device and the peripheral device, the control threshold ranges comprises a plurality of distance threshold ranges, each of the distance threshold ranges corresponds to one of the second wireless communication modules, the control unit obtains the relative distance based on at least one of a sensing result of one of the first wireless communication modules and a sensing result of one of the corresponding second wireless communication modules.

3. The wireless communication control system of claim 2, wherein when the control unit determines that the relative distance is within a tolerance range corresponding to the Ith distance threshold range, the control unit turns on the Ith second wireless communication module corresponding to the Ith distance threshold range and turns off the other second wireless communication module(s), and I is a positive integer.

4. The wireless communication control system of claim 2, wherein when the control unit determines that the relative distance is within a tolerance range corresponding to the Ith distance threshold range and I is a positive integer greater than 1, the control unit turns on the Ith second wireless communication module corresponding to the Ith distance threshold range and the I−1th second wireless communication module corresponding to the I−1th distance threshold range, turns off the other second wireless communication module(s), and the Ith distance threshold range is greater than the I−1th distance threshold range.

5. The wireless communication control system of claim 1, wherein when the control parameter comprises the residual electrical quantity of the movable device, the control threshold ranges comprises a plurality of electrical quantity threshold ranges, each of the electrical quantity threshold ranges corresponds to one of the second wireless communication modules, the movable device further comprises a power supply unit, the control unit is coupled to the power supply unit, and the control unit obtains the residual electrical quantity from the power supply unit.

6. The wireless communication control system of claim 5, wherein when control unit determines that the residual electrical quantity is within a tolerance range corresponding to the Jth electrical quantity threshold range, the control unit turns on the Jth second wireless communication module corresponding to the Jth electrical quantity threshold range and turns off the other second wireless communication module(s), and J is a positive integer.

7. The wireless communication control system of claim 1, wherein when the control parameter comprises the relative speed between the movable device and the peripheral device, the control threshold ranges comprises a plurality of speed threshold ranges, each of the speed threshold ranges corresponds to one of the second wireless communication modules, the peripheral device further comprises a first speed detecting unit, the movable device further comprises a second speed detecting unit, the control unit is coupled to the second speed detecting unit, the control unit obtains the relative speed based on a sensing result of the first speed detecting unit and a sensing result of the second speed detecting unit.

8. The wireless communication control system of claim 7, wherein when the control unit determines that the relative speed is within a tolerance range corresponding to the kth speed threshold range, the control unit turns on the kth second wireless communication module corresponding to the kth speed threshold range and turns off the other second wireless communication module(s), and k is a positive integer.

9. A wireless communication control method applicable to a movable device, the movable device being capable of moving with respect to a peripheral device, the peripheral device comprising a plurality of first wireless communication modules, the movable device comprising a memory unit and a plurality of second wireless communication modules, each of the second wireless communication modules corresponding to one of the first wireless communication modules, the memory unit storing a plurality of control threshold ranges, each of the control threshold ranges corresponding to one of the second wireless communication modules, the wireless communication control method comprising:
comparing a control parameter with the control threshold ranges, wherein the control parameter comprises at least one of a relative distance between the movable device and the peripheral device, a residual electrical quantity of the movable device, and a relative speed between the movable device and the peripheral device; and
turning on at least one of the second wireless communication modules and turning off the other second wireless communication module (s) when the control parameter is within one of the control threshold ranges.

10. The wireless communication control method of claim 9, wherein when the control parameter comprises the relative distance between the movable device and the peripheral device, the control threshold ranges comprises a plurality of distance threshold ranges, each of the distance threshold ranges corresponds to one of the second wireless communication modules, the wireless communication control comprising:
obtaining the relative distance based on at least one of a sensing result of one of the first wireless communication modules and a sensing result of one of the corresponding second wireless communication modules.

11. The wireless communication control method of claim 10, further comprising:
turning on the Ith second wireless communication module corresponding to the Ith distance threshold range and turning off the other second wireless communication module(s) when the relative distance is within a tolerance range corresponding to the Ith distance threshold range, wherein I is a positive integer.

12. The wireless communication control method of claim 10, further comprising:
turning on the Ith second wireless communication module corresponding to the Ith distance threshold range and the I−1th second wireless communication module corresponding to the I−1th distance threshold range, and turning off the other second wireless communication module(s) when the relative distance is within a tolerance range corresponding to the Ith distance threshold range, wherein I is a positive integer greater than 1 and the Ith distance threshold range is greater than the I−1th distance threshold range.

13. The wireless communication control method of claim 9, wherein when the control parameter comprises the residual electrical quantity of the movable device, the control threshold ranges comprises a plurality of electrical quantity threshold ranges, each of the electrical quantity threshold ranges corresponds to one of the second wireless communication modules, the movable device further comprises a power supply unit, the wireless communication control method further comprising:
obtaining the residual electrical quantity from the power supply unit.

14. The wireless communication control method of claim 13, further comprising:
turning on the Jth second wireless communication module corresponding to the Jth electrical quantity threshold range and turning off the other second wireless communication module (s) when the residual electrical quantity is within a tolerance range corresponding to the Jth electrical quantity threshold range, wherein J is a positive integer.

15. The wireless communication control method of claim 9, wherein when the control parameter comprises the relative speed between the movable device and the peripheral device, the control threshold ranges comprises a plurality of speed threshold ranges, each of the speed threshold ranges corresponds to one of the second wireless communication modules, the peripheral device further comprises a first speed detecting unit, the movable device further comprises a second speed detecting unit, the wireless communication control method further comprising:
obtaining the relative speed based on a sensing result of the first speed detecting unit and a sensing result of the second speed detecting unit.

16. The wireless communication control method of claim 15, further comprising:
turning on the kth second wireless communication module corresponding to the kth speed threshold range and turning off the other second wireless communication module(s) when the relative speed is within a tolerance range corresponding to the kth speed threshold range, wherein k is a positive integer.

17. A movable device capable of moving with respect to a peripheral device, the peripheral device comprising a plurality of first wireless communication modules, the movable device comprising:
a plurality of second wireless communication modules, each of the second wireless communication modules corresponding to one of the first wireless communication modules;
a memory unit storing a plurality of control threshold ranges, each of the control threshold ranges corresponding to one of the second wireless communication modules; and
a control unit coupled to the memory unit and the second wireless communication modules;
wherein when the control unit determines that a control parameter is within one of the control threshold ranges, the control unit selectively turns on at least one of the second wireless communication modules and turns off the other second wireless communication module(s), and the control parameter comprises at least one of a relative distance between the movable device and the peripheral device, a residual electrical quantity of the movable device, and a relative speed between the movable device and the peripheral device.

18. The movable device of claim 17, wherein when the control parameter comprises the relative distance between the movable device and the peripheral device, the control threshold ranges comprises a plurality of distance threshold ranges, each of the distance threshold ranges corresponds to one of the second wireless communication modules, and the control unit obtains the relative distance based on at least one of a sensing result of one of the first wireless communication modules and a sensing result of one of the corresponding second wireless communication modules.

19. The movable device of claim 18, wherein when the control unit determines that the relative distance is within a tolerance range corresponding to the Ith distance threshold range, the control unit turns on the Ith second wireless communication module corresponding to the Ith distance threshold range and turns off the other second wireless communication module(s), and I is a positive integer.

20. The movable device of claim 18, wherein when the control unit determines that the relative distance is within a tolerance range corresponding to the Ith distance threshold range and I is a positive integer greater than 1, the control unit turns on the Ith second wireless communication module corresponding to the Ith distance threshold range and the I−1th second wireless communication module corresponding to the I−1th distance threshold range, turns off the other second wireless communication module(s), and the Ith distance threshold range is greater than the I−1th distance threshold range.

21. The movable device of claim 17, further comprising a power supply unit, the control unit being coupled to the power supply unit, wherein when the control parameter comprises the residual electrical quantity of the movable device, the control threshold ranges comprises a plurality of electrical quantity threshold ranges, each of the electrical quantity threshold ranges corresponds to one of the second wireless communication modules, and the control unit obtains the residual electrical quantity from the power supply unit.

22. The movable device of claim 21, wherein when control unit determines that the residual electrical quantity is within a tolerance range corresponding to the Jth electrical quantity threshold range, the control unit turns on the Jth second wireless communication module corresponding to the Jth electrical quantity threshold range and turns off the other second wireless communication module(s), and J is a positive integer.

23. The movable device of claim 17, further comprising a second speed detecting unit, the peripheral device further comprising a first speed detecting unit, the control unit being coupled to the second speed detecting unit, wherein when the control parameter comprises the relative speed between the movable device and the peripheral device, the control threshold ranges comprises a plurality of speed threshold ranges, each of the speed threshold ranges corresponds to one of the second wireless communication modules, and the control unit obtains the relative speed based on a sensing result of the first speed detecting unit and a sensing result of the second speed detecting unit.

24. The movable device of claim 23, wherein when the control unit determines that the relative speed is within a tolerance range corresponding to the kth speed threshold range, the control unit turns on the kth second wireless communication module corresponding to the kth speed threshold range and turns off the other second wireless communication module(s), and k is a positive integer.
